(19) United States
(12) Patent Application Publication
(10) Pub. No.: US 2026/0016812 A1
(43) Pub. Date: Jan. 15, 2026

(54) DYNAMIC PROCESS CONTROL IN ELECTRONIC DEVICE MANUFACTURING

(71) Applicant: Applied Materials, Inc., Santa Clara, CA (US)

(72) Inventors: Mauro Cimino, Santa Clara, CA (US); Dmitry Lubomirsky, Cupertino, CA (US)

(21) Appl. No.: 18/770,641

(22) Filed: Jul. 11, 2024

(51) Int. Cl. G05B 19/4155

(52) U.S. Cl. CPC G05B 19/4155; G05B 2219/45031

(57) ABSTRACT

A method includes receiving a first data set for a first process run of a process recipe, the first data set comprising first process parameter values, first performance data and target performance data of the process recipe. The method further includes process the first data set using a dynamic controller to determine second process parameter values that differ from the first process parameter values for at least one process parameter. The method further includes receiving a second data set for a second process run of the process recipe, the second data set comprising the second process parameter values, second performance, and the target performance data of the process recipe. The method further includes, responsive to determining that the second performance data satisfies one or more criteria with respect to the target performance data, saving the second process parameter values as final process parameter values for the process recipe.

### TECHNICAL FIELD

The instant specification generally relates to process control. More specifically, the instant specification relates to dynamic process control for processing of electronic devices such as semiconductor devices to control feature scale.

### BACKGROUND

Semiconductor processing involves numerous intricate production processes to transform raw materials such as silicon into integrated circuits (ICs) used in electronic devices. The process encompasses wafer fabrication, device assembly, and packaging. Process control can be performed to maintain the consistency, quality, and efficiency of the production processes. Process control can include process engineers manually monitoring and adjusting various parameters throughout the manufacturing stages to meet stringent specifications and reduce variability. Effective process control can lead to higher yields, reduced costs, and improved device performance.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In one aspect of the disclosure, a method includes receiving a first data set for a first process run of a process recipe, the first data set comprising first process parameter values for process parameters of the process recipe, first performance data of the process recipe performed on a first substrate using the first process parameter values, and target performance data of the process recipe. The method further includes processing the first data set using a dynamic controller to determine second process parameter values for the process parameters of the process recipe, wherein the second process parameter values differ from the first process parameter values for at least one process parameter. The method further includes receiving a second data set for a second process run of the process recipe, the second data set comprising the second process parameter values, second performance data of the process recipe performed on a second substrate using the second process parameter values, and the target performance data of the process recipe. The method further includes, responsive to determining that the second performance data satisfies one or more criteria with respect to the target performance data, saving the second process parameter values as final process parameter values for the process recipe.

In another aspect of the disclosure, a system includes a memory and a processing device coupled to the memory, the processing device to receive a first data set for a first process run of a process recipe, the first data set comprising first process parameter values for process parameters of the process recipe, first performance data of the process recipe performed on a first substrate using the first process parameter values, and target performance data of the process recipe. The processing device is further to process the first data set using a dynamic controller to determine second process parameter values for the process parameters of the process recipe, wherein the second process parameter values differ from the first process parameter values for at least one process parameter. The processing device is further to receive a second data set for a second process run of the process recipe, the second data set comprising the second process parameter values, second performance data of the process recipe performed on a second substrate using the second process parameter values, and the target performance data of the process recipe. The processing device is further to save the second process parameter values as final process parameter values for the process recipe responsive to determining that the second performance data satisfies one or more criteria with respect to the target performance data.

In another aspect of the disclosure, a non-transitory machine-readable storage medium includes instructions that, when executed by a processing device, cause the processing device to perform operations. The operations include receiving a first data set for a first process run of a process recipe, the first data set comprising first process parameter values for process parameters of the process recipe, first performance data of the process recipe performed on a first substrate using the first process parameter values, and target performance data of the process recipe. The operations further includes processing the first data set using a dynamic controller to determine second process parameter values for the process parameters of the process recipe, wherein the second process parameter values differ from the first process parameter values for at least one process parameter. The operation further include receiving a second data set for a second process run of the process recipe, the second data set comprising the second process parameter values, second performance data of the process recipe performed on a second substrate using the second process parameter values, and the target performance data of the process recipe. The operations further include, responsive to determining that the second performance data satisfies one or more criteria with respect to the target performance data, saving the second process parameter values as final process parameter values for the process recipe.

### BRIEF DESCRIPTION OF THE DRAWINGS

Aspects and implementations of the present disclosure will be understood more fully from the detailed description given below and from the accompanying drawings, which are intended to illustrate aspects and implementations by way of example and not limitation.

FIG. 1 depicts a sectional view of a manufacturing chamber, according to some embodiments.

FIG. 2 is an example of metrology and performance data of a substrate, according to some embodiments.

FIG. 3A is a flow diagram of a method associated with dynamic process control for recipe design, according to certain embodiments.

FIG. 3B is a flow diagram of a method associated with process control for semiconductor processing, according to certain embodiments.

FIG. 3C is a flow diagram of a method associated with process control for semiconductor processing, according to certain embodiments.

FIG. 3D is a flow diagram of a method associated with process control for semiconductor processing, according to certain embodiments.

FIG. 4 is a block diagram illustrating an example system architecture, according to certain embodiments.

FIG. 5 is a block diagram illustrating a computer system, according to certain embodiments.

### DETAILED DESCRIPTION

Embodiments of the present disclosure are directed to systems and methods for dynamic process control for electronics processing using a dynamic controller.

Semiconductor manufacturing is a complex, multi-step process that transforms raw substrates (e.g., such as silicon wafers) into functional integrated circuits (ICs). Semiconductor manufacturing may include cleaning processes, oxidation processes, lithography processes, etching processes, doping processes, deposition processes (e.g., such as chemical vapor deposition (CVD), physical vapor deposition (PVD), atomic layer deposition (ALD), etc.), planarization processes, and so on. Each of the processes that are performed for semiconductor manufacturing may be performed according to a process recipe having process parameters that affect the ultimately manufactured semiconductor devices. These process recipes benefit from precise control over the values of process parameters of the process recipes to help ensure the correct formation of microscale and nanoscale features on semiconductor substrates.

Conventionally, management of process recipes and their respective process parameters involves the utilization of detailed physical models, large designs of experiment (DOEs) that consume time and resources, and manual recipe tuning by experienced engineers. For recipe design and control, an engineer traditionally manually adjusts process parameter values one or two at a time until a recipe provides a target output. Such a process for recipe development is both time-consuming and resource-intensive, involving process engineers analyzing model outputs for physical models (e.g., software models of a physical system) of a process and actual metrology data of process runs for the process. Furthermore, the process parameter values used in a physical model do not always accurately correlate to actual processing output. For example, these models can still exhibit discrepancies when process conditions deviate from the model's base assumptions.

Metrology data provides information about substrate metrology, such as feature dimensions and overall thickness, providing a clear measure of process performance at the end of each process recipe. Metrology data can help to assess process quality and performance. Typically, the optimization process is iterative, with adjustments to the process or recipe made based on the metrology results obtained from previous iterations. In current practices, parameters of a process recipe are changed one or two at a time, followed by metrology to analyze the results. Arriving at the optimal process recipe in this manner is highly time-consuming and often inefficient. Each iteration incurs significant financial costs, including the material costs associated with scrapped iterations.

One class of example processes that are performed for semiconductor processing stages are plasma material processing processes. In semiconductor manufacturing applications, plasma etching refers to the process of removing materials from the surface of a substrate using plasma. The plasma is generated when a selected gas gets ionized by an electromagnetic field. The power of a radio frequency (RF) source that contributes to the generation of such a field, a pressure in a semiconductor chamber in which the process is performed, a gas utilized for the process, the geometry of the chamber, and several other process parameters and chamber conditions determine the depth of the etching as well as the rate of etching. Ions bombarding the surface of the substrate during processing can be further accelerated where etching occurs via the application of a radiofrequency (RF) bias.

While the etching process handles the creation of “trenches” (or features of the substrate) on the substrate, a subsequent gap-filling process has been utilized in semiconductor process chambers to deposit an insulating film at the bottom and sidewalls of the trenches. Such a process can be performed using a chemical vapor deposition (CVD) method, or with an atomic layer deposition method that uses plasma.

Issues related to the use any of such methods relate to the undesired distribution of the insulating film on the bottom, top, and side walls of trenches. In particular, the insulating film thickness on any of those three regions of a trench can be in excess, subset to defects, and/or unevenly distributed across the region. In addition, the overall film thickness may be unevenly distributed across the substrate, revealing the presence of trenches where the result may be acceptable and other trenches where the result is not acceptable.

A model of the physical etch process can be generated for a given process chamber, process recipe and chemistry. Such a model can describe the evolution of the feature scale (i.e., the evolution of features on the semiconductor substrate) throughout the entirety of the process undergone by the substrate. The opportunity to monitor the evolution of the feature scale through a model output confers insight into the physical process itself (even allowing the model output to predict the presence of voids) and helps in the design of process chambers as well as the optimization of existing process recipes.

The optimization of process recipes and chamber conditions is very time, financial and resource intensive. Process engineers generally manually review feature-scale model outputs (when available) as well as metrology data. The latter provides information about one or more individual features on the substrate (e.g., wafer), as well as its overall thickness. Such metrology data provides a clear picture of the process performance at the end of the substrate processing sequence, and can be utilized to derive a quantitative measure of a process's quality and performance. The analysis and optimization of the metrology data often is an iterative process, where the next process/recipe adjustments are made as a function of the process results (from metrology) obtained in a previous iteration. A financial cost is associated to each iteration, including the cost of the material to be scrapped at the end of each iteration. Moreover, the resource intensiveness of the optimization process is due to the high number of iterations (possibly taking several days), and to the continuous involvement of highly skilled process engineers.

A feature scale model output utilized at a chamber design stage can also be utilized at a recipe optimization stage. However, the complexity of such models and the fact that they provide information not just about the end-result, but also about the intermediate evolution of features, contribute to making simulations of such models very time and resource intensive. In fact, it could take hours to generate a full simulation of the semiconductor feature scale, hence making simulations not accessible at the processing site itself. Moreover, even though models can be very accurate, any deviation of process conditions outside the ranges for which the model was derived may result in a discrepancy between a modeled feature scale and the metrology feedback.

One possible alternative approach to process recipe development involves using machine learning models, such as neural networks, to output process parameters that aim to achieve target outputs. However, these machine learning models are specifically trained for a given task. It takes substantial amounts of data and significant time to train such machine learning models. Furthermore, if the task changes, the machine learning model is retrained all over again before it can be useful for recipe design of the new task, which can again be a time-consuming and data-intensive process.

Aspects and implementations of the present disclosure address these and other challenges of the existing technology by providing systems and methods for dynamic process control in semiconductor processing. In some embodiments, a dynamic controller can be used to refine and optimize recipes. For example, a dynamic controller can determine updated process parameter values of process parameters for a process recipe based on performance data from just a few process runs. The performance data can include, for example, metrology data of one or more substrates processed during the one or a few process runs of a process recipe.

Embodiments described herein provide a process control system and methodology that are usable to quickly optimize process recipes, such as for plasma processes, etch processes, gap-filling processes, and so on. In embodiments, a dynamic controller such as a multiple input-multiple output (MIMO) controller is used for process recipe development. The dynamic controller can be used to facilitate process recipe development in a manner that reduces the number of iterations of the optimization process, limits the involvement of highly skilled personal, reduces the cost associated with the iterative nature of the optimization process, improves feature scale results, compensates for modeling errors on feature scale, and/or generates automatic process adjustments/suggestions in embodiments.

In embodiments, a dynamic controller can determine adjustments to process parameters using dynamic control. For example, the dynamic controller can calculate performance error values based on differences between target performance data and measured performance data. The dynamic controller can further calculate modeling error values based on differences between measured performance data and predicted performance data (e.g., based on process parameter values of a process run) and then adjust control coefficients of differential equations of the dynamic controller based on the modeling error values. After adjusting the control coefficients based on the modeling error values, the process parameter values can be updated by the dynamic controller in order to achieve target performance data. With each iteration of inputting data into the dynamic controller and updating the control coefficients and/or the process parameter values the dynamic controller can more accurately achieve updated process parameters values that achieve the target output.

The dynamic controller has advantages over a machine learning model in that the dynamic controller can be trained with a minimal amount of training data. For example, the dynamic controller can be trained with the data from as few as three process runs. The total number of iterations used to train the dynamic controller depends on the number of process recipe parameters to be manipulated/adjusted, the feasibility of the target output, the repeatability of the process results (e.g., the expectation that the same recipe parameters lead to same outputs), the stability margins (e.g., threshold criteria of criteria with respect to target performance data), and the near-singularity of the target condition (e.g., whether the target is a singular point in the process result space). In contrast, in order to train a machine learning model large quantities (e.g., thousands or more runs) of training data are used.

In some embodiments, the dynamic controller outputs updated process parameter values that are used to process subsequent substrates (e.g., a second substrate) after processing data from a first substrate. Updated performance data (e.g., second performance data) may be extracted from the processing of the one or more additional substrates. For example, a second run of the process recipe using the updated process parameter values can be performed to generate a second processed substrate, and performance data of the second processed substrate can be obtained. In some embodiments, if the performance data of the second processed substrate meets certain criteria with respect to target performance data, the updated process parameter values can be saved as final process parameters for a process recipe.

However, if the performance data of the second substrate does not meet the criteria with respect to the target performance data, the dynamic controller can again determine further updated process parameter values based on the previously updated process parameter values, the performance data from the second process run using the updated process parameter values on the second substrate, and target performance data for the second process run. In some embodiments, the process of updating the process parameter values and determining if the updated values produce a substrate having performance data that matches the target performance data can be iterative. The iterative process may be repeated until the performance data of a substrate substantially algins with the target performance data.

In some use cases, the dynamic controller can determine process parameter values that satisfy the criteria in at most three iterations. In some use cases the dynamic controller can determine process parameter values that satisfy the criteria in at most 4 iterations, 5 iterations, 6 iterations, and so on. The iterations each being based on a unique set of process parameter values output by dynamic controller 150. By training the dynamic controller for a process recipe, process parameter value refinement can be expedited. In some embodiments, the dynamic controller can be trained prior to receiving the first data set by providing multiple data sets associated with a design of experiments (DOE) for a process recipe. Each data set can contain unique combinations of process parameter values and corresponding performance data. By training the dynamic controller on such data sets for a certain process recipe, the dynamic controller makes adjustments to control coefficients optimizing the process of refining process parameter values of process parameters of the process recipe.

Aspects and implementations of the present disclosure can reduce the number of iterations of the optimization process as compared to making manual adjustments to process parameter values one or two at a time until a recipe provides a target output. Aspects and implementations of the present disclosure can limit the involvement of highly skilled personal to only the most critical steps as compared to conventional manual tuning of process recipes using physical models and design experiments. Aspects and implementations of the present disclosure can reduce the cost associated with the iterative nature of the optimization process (e.g., by reducing the need for highly skilled personnel in manual recipe tuning). Aspects and implementations of the present disclosure can improve feature scale results as compared to manual tuning of process recipes (e.g., by adjusting one to two variables per iteration) using physical models and design experiments. Aspects and implementations of the present disclosure can compensate for modeling errors on feature scale. Aspects and implementations of the present disclosure can generate automatic process adjustments and/or suggestions that use significantly less manual tuning than conventional manual tuning of process recipes using physical models and design experiments.

Aspects and implementations of the present disclosure can be less time-consuming and resource-intensive than conventional solutions. For example, time is saved by reducing the number of iterations performed to arrive at final process parameter values. The involvement of process engineers is also reduced by eliminating or reducing process engineer analysis of model outputs and of metrology data of process runs. Aspects and implementations of the present disclosure can output final process parameter values that accurately correlate to actual process output. For example, aspects and implementations of the present disclosure can be adapted (e.g., by further training or retraining) without significant loss of time or resources when process conditions deviate.

Aspects and implementations of the present disclosure can adjust some or all of the process parameters of a process recipe in a single iteration, expediting arrival at the optimal process recipe. In contrast, typical process refinement includes modifying only one or two process parameter values at a time, which makes process refinement more time consuming. In some embodiments, by reducing the number of iterations of process development, financial costs (including the material costs associated with scrapped iterations) are reduced. Aspects and implementations of the present disclosure can be specifically trained for a given task or recipe; however, the training process does not use substantial amounts of data or significant time to train. In some embodiments, if the task or recipe changes, aspects and implementations of the present disclosure can be retrained with minimal data and in a time-efficient manner.

Although some embodiments of the present disclosure describe process control in a semiconductor processing system, the present disclosure can be used for process control in any kind of processing system or for any kind of manufacturing. Embodiments are discussed with reference to semiconductor devices and semiconductor processing. However, it should be understood that embodiments described herein with reference to semiconductor devices and semiconductor processing also applies to devices and processing for displays, photovoltaics, and other types of electronics devices.

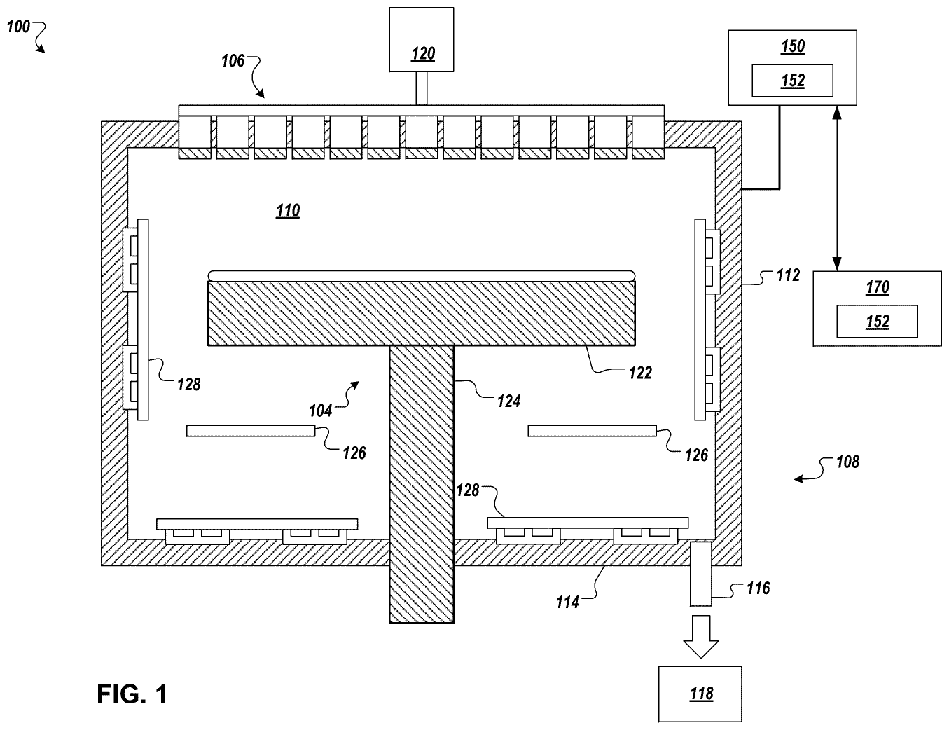

FIG. 1 depicts a sectional view of a manufacturing chamber 100 (e.g., a semiconductor process chamber), according to some aspects of this disclosure. Manufacturing chamber 100 may be one or more of an etch chamber (e.g., a plasma etch chamber), deposition chamber (including atomic layer deposition, chemical vapor deposition, physical vapor deposition, or plasma enhanced versions thereof), anneal chamber, or the like. For example, manufacturing chamber 100 may be a chamber for a plasma etcher, a plasma cleaner, an atomic layer deposition (ALD) device, a chemical vapor deposition (CVD) device, and so forth. Examples of chamber components may include a substrate support assembly 104, an electrostatic chuck, a ring (e.g., a process kit ring), a chamber wall, a base, a showerhead 106, a gas distribution plate, a liner, a liner kit, a shield, a plasma screen, a flow equalizer, a cooling base, a chamber viewport, a chamber lid, a nozzle and so on.

Manufacturing chamber 100 may be used to perform one or more processes on substrates using one or more process recipes. Process recipes to be run by the process chamber may be optimized and refined using a dynamic controller, which may run on controller 150 of the process chamber and/or on a server computing device at a same facility (e.g., fab, laboratory, etc.) as the process chamber, or at a remote location from the process chamber.

In one embodiment, manufacturing chamber 100 may include a chamber body 108 and a showerhead 106 that enclose an interior volume 110. In some chambers, showerhead 106, may be replaced by a lid and a nozzle. Chamber body 108 may be constructed from aluminum, stainless steel, or other suitable material. Chamber body 108 generally includes sidewalls 112 and a bottom 114.

An exhaust port 116 may be defined in chamber body 108 and may couple interior volume 110 to a pump system 118. Pump system 118 may include one or more pumps and valves utilized to evacuate and regulate the pressure of interior volume 110 of manufacturing chamber 100. An actuator to control gas flow out of the chamber and/or pressure in the chamber may be disposed at or near exhaust port 116.

Showerhead 106 may be supported on sidewalls 112 of chamber body 108 or on a top portion of the chamber body. Showerhead 106 (or the lid, in some embodiments) may be opened to allow access to interior volume 110 of manufacturing chamber 100 and may provide a seal for manufacturing chamber 100 while closed.

Substrate support assembly 104 may be disposed in interior volume 110 of manufacturing chamber 100 below showerhead 106. In some embodiments, substrate support assembly 104 includes a susceptor 122 and shaft 124. Substrate support assembly 104 supports a substrate during processing. In some embodiments, also disposed within manufacturing chamber 100 are one or more heaters 126 and reflectors 128.

Gas panel 120 may be coupled to manufacturing chamber 100 to provide process or cleaning gases to interior volume 110 through showerhead 106 (or lid and nozzle). The gas panel 120 may be coupled to the manufacturing chamber 100 to provide process and/or cleaning gases via one or more supply line to the interior volume 110 through showerhead 106. The gas panel 120 may include or be connected to one or more flow control apparatus (e.g., one or more MFCs). The flow control apparatus(es) may be used to measure and control the flow of one or more gasses from one or more gas sources (e.g., gas sticks) to interior volume 110.

A controller 150 may be coupled to manufacturing chamber 100 in embodiments. The controller 150 may control operation of the process chamber and other systems connected to and/or associated with the process chamber, such as operation of the gas panel 120, heaters 126, substrate support assembly 104, pump system 118, and so on. The controller 150 may additionally or alternatively control operation of one or more metrology devices, wafer transfer robots, a transfer chamber, a factory interface, and so on. The controller 150 may control the processing of substrates and transferring of substrates in and out of process chamber 100. Controller 150 may include, e.g., a general purpose computer and/or may include a microprocessor or other suitable CPU (central processing unit), a memory for storing software routines that control electronic device manufacturing system, input/output peripherals, and support circuits (such as, e.g., power supplies, clock circuits, and the like). Controller 150 may be programmed to, e.g., process one or more substrates at a time.

Controller 150 may execute a process recipe to cause process chamber 100 to perform a manufacturing process on one or more substrates. The manufacturing process may be, for example, a plasma etch process, a gap-fill process, CVD process, a PVD process, or other type of process. The manufacturing process may be encapsulated in a process recipe, which may be executed and/or refined using a dynamic controller 152 that executes on controller 150 in some embodiments.

In some embodiments, dynamic controller 152 executes on controller 150. In some embodiments, dynamic controller 152 executes on a server computing device 170, which may be connected to controller 150 directly or via a network, such as a local area network (LAN) and/or wide area network (WAN) such as the Internet. Dynamic controller 152 may provide updates to recipes to be executed by controller 150 in embodiments.

Dynamic controller 152 is an advanced type of control system designed to manage and optimize the performance of dynamic processes that change over time. Unlike static controllers, which operate based on a fixed set of rules, dynamic controllers continuously adjust their parameters in response to real-time data and changing conditions. Dynamic controller 152 includes one or more mathematical models, which may be derived based on first principles and/or from empirical data (e.g., from a DOE).

In some embodiments, the dynamic controller 152 can be a multiple input-multiple output (MIMO) controller. MIMO controllers can handle systems with multiple inputs and outputs, enabling simultaneous control of various factors and their interactions. MIMO controllers leverage advanced algorithms to coordinate control actions across multiple inputs and outputs simultaneously, ensuring optimal performance and stability. In a MIMO controller, changes to one input can affect multiple outputs due to the interdependencies and coupling between variables. Dynamic controller 150 can refine process parameter values for process parameters of a process recipe so that a run of the process recipe achieves a target output. For example, dynamic controller 150 may receive a first data set for a first iteration of a process run of a process recipe.

The first data set includes first process parameter values for process parameters of the process recipe. The first process parameter values for process parameters of the process recipe can be initial process parameter values used during an in-line learning process of the dynamic controller 150 for a process recipe without a design of experiments having been run. Alternatively, these first process parameter values can be the first set of parameter values following an initial training process based on a design of experiments (DOE). For example, the first process parameters can be pre-tuned or refined parameters that have been determined based on the initial training process. The first process parameter values can be a starting point for refinement of a process recipe based on the initial training. The initial training prepares dynamic controller 150 to be able to adjust the first process parameter values to achieve a distinct target output of the recipe in embodiments.

The first data set further includes corresponding first performance data of the process recipe performed on a first substrate using the first process parameter values. The first process parameter values may include, for example, first temperature setpoints, first pressure setpoints, first plasma power setpoints, first plasma bias setpoints, first gas flow setpoints for one or more process gases, and so on. The first process parameter values can be used in a first run of the process recipe. Subsequently, metrology data of the first substrate processed by the first run of the process recipe using the first process parameter values is determined. In some embodiments, the metrology data of the first substrate can include first performance data. Performance data can include one or more measurements from metrology data of a processed substrate (e.g., the first substrate) that indicate one or more measurable properties such as critical dimensions of formed structures, layer thicknesses, surface roughness, and so on. Examples of metrology equipment that may be used to generate the metrology data include reflectometers, scanning electron microscopes (SEMs), transmission electron microscopes (TEMs), optical sensors, spectrometers, and so on. In some embodiments, the metrology equipment is used to generate images of the substrate after processing, and one or more dimensions of structures formed on the substrate (e.g., critical dimensions) may be measured from the images. In some embodiments, the metrology data can be processed using a trained machine learning model to generate at least one of the first performance data or the second performance data. For example, image data may be processed using a trained machine learning model to identify one or more structures or features in the images and/or to generate automated measurements of the one or more structures or features in the images. In one embodiment, the trained machine learning model may perform instance segmentation or semantic segmentation to identify objects in the image data. A result of the segmentation may be a segmentation map and/or one or more segmentation masks that identify pixels associated with different objects. Measurements may then be automatically performed by the machine learning model, by another machine learning model, or by an image processing system to measure points on and/or between detected objects (e.g., to measure critical dimensions). In some instances, a user may manually measure one or more features (e.g., critical dimensions) in the image data with or without segmentation having been performed. Further details with respect to collection and/or generation of metrology data will be provided herein below.

The first data set further includes target performance data of the process recipe. In some embodiments, the target performance data of the process recipe can be target metrology data of the first substrate. For example, a process recipe for a deposition may have a target thickness for the deposition recipe. In another example, a structure being fabricated on a substrate may have one or more target critical dimensions.

The first data set can be used to determine predicted performance data. For example, the first process parameter values of the first data set can be provided to dynamic controller 150. These parameter values are input (e.g., by controller 150) into a physical model that simulates the system (e.g., a process chamber). This model, which may be integrated within the controller or may operate independently from the controller 150, utilizes the inputs to generate predicted performance data (e.g., the expected outcomes of the process under the specific parameters provided).

The first process parameters are adjusted by the dynamic controller to achieve or approach the target performance data (e.g., target thickness for the deposition recipe, target critical dimensions, etc.). The first process parameters are adjusted by the dynamic controller 150 based on the performance data of the first substrate in light of the first process parameter values and the target performance data of the process recipe. The dynamic controller 150 may apply this data to one or more equations of the dynamic controller, which may output updated process parameter values for one or more of the process parameters. The adjusted first process parameters may include one or more second process parameter values. For example, dynamic controller 150 can determine second process parameter values of the deposition recipe based on the first process parameter values for process parameters of a deposition recipe, first thickness data from a first process run of the deposition recipe, and target thickness data for the deposition recipe.

In some embodiments, dynamic controller 150 determines second process parameter values by determining a difference between first performance data and the target performance data and calculating error values based on the difference between the first performance data and the target performance data. For example, a target thickness data of a deposition recipe may be 20 angstroms while the actual thickness data of the first process run may be 15 angstroms. In such an example, the difference between the first performance (thickness) data of the first process run and the target performance (thickness) data is five angstroms.

The equations (e.g., differential equations) and/or mathematical models of the dynamic controller 150 relate performance data values to one or more process parameter values. Accordingly, the dynamic controller may process updated performance data together with process parameter values used to generate the performance data using the mathematical models to generate updated process parameter values. Additionally, weights (control coefficients) of the mathematical models themselves may also be adjusted based on the predicted performance data and the historical performance data. Accordingly, dynamic controller 150 can adjust the weights based on the modeling error values (e.g., the difference between expected performance and historical performance data).

In some embodiments, determining the difference between the first performance data and the target performance data includes determining a direction and magnitude of change between the first performance data and the target performance data. In some embodiments, a magnitude represents how far the actual performance data deviates from the target performance data, providing a scalar value of the performance error, while the direction indicates whether the adjustment is to increase or decrease the process parameter values to achieve the target performance data. The difference between target performance data and historical performance data is referred to as performance error. Adjustments are made to both the magnitude and direction of process parameter values based on the performance error, ensuring that they are precisely calibrated to align with the target system performance.

Adjustments are further made to the control coefficients (e.g., based on the modeling error). The difference between historic performance data and the predicted performance data (e.g., as predicted by a software model of the physical system) is referred to as the modeling error. Furthermore, the adaptation of the control coefficients is specifically guided by the modeling error. This distinction ensures that each adjustment is precisely targeted and effectively oriented towards optimizing the system's performance.

In some embodiments, control coefficients of dynamic controller 150 can be control coefficients for differential equations (which may be part of a mathematical model). These control coefficients can determine the dynamics and stability of the system being controlled, such as damping ratios, natural frequencies, and/or time constants in the equations. Adjusting these coefficients can calibrate the controller's response to meet target outputs. The adjustment process involves fine-tuning control coefficients based on specific performance criteria of the controller, such as refining process parameter values of a process recipe. In some embodiments, analytical methods, numerical optimization, or experimental tuning can be used to adjust control coefficients.

In some embodiments, control coefficients can be adjusted based on training data from historical runs of the system (e.g., a first data set and/or DOE). Training data from historical runs of the system can reflect how the system has performed (e.g., performance data) with various parameter setting values (parameters data) in the past. Performance data can be collected via metrology measurements following a run of a process recipe. Predicted performance data can be collected by inputting process parameters values into a physics-based simulation model, which then generates anticipated outcomes for the process recipe.

In some embodiments, performance error values can be calculated based on the training data from historical runs of the system and target performance data. In dynamic control systems utilizing differential equations, performance error values can be calculated by determining the difference between a target setpoint (e.g., target performance) and the actual system output (e.g., performance data). This is sometimes referred to as the error signal. This error signal can quantify the difference between current performance of the system and target performance. In some embodiments, the error signals can be fed into a feedback loop of the dynamic controller, where the error signals inform adjustments to the control actions (e.g., adjustment of control coefficients). For controllers like Proportional-Integral-Derivative (PID) controllers, this involves adjusting, for example, the proportional coefficient which amplifies the error to adjust the control action more aggressively, the integral coefficient which integrates the error over time and addresses cumulative past errors to eliminate steady-state discrepancies, and the derivative coefficient which multiplies the rate of change of the error, enhancing the system's predictive and stabilizing capabilities.

The first process parameter values can be input into dynamic controller 150 and the dynamic controller 150 can determine second process parameter values. The second process parameter values are an adjusted version of the process parameters. The adjustments to the first process parameter values are made with the aim of achieving the target output (e.g., target performance data).

In some embodiments, after receiving the first data set the dynamic controller 152 outputs the second process parameter values and the second process parameter values are used to process a second substrate from which second performance data is extracted (e.g., via metrology). In some embodiments, a second data set of the second process run of the process recipe includes the second process parameter values, second performance data of the process recipe performed on the second substrate using the second process parameter values, and the target performance data of the process recipe. For example, a second run of the process recipe using the second process parameter values can generate a second processed substrate and performance data of the second substrate can be obtained via metrology measurements. In some embodiments, if the performance data of the second substrate meets certain criteria with respect to the target performance data, the updated process parameter values can be saved as final process parameters for the process recipe.

For example, a target thickness data of a deposition recipe can be 20 angstroms. The actual thickness data (performance data) of the first process run may be 19 angstroms. In such an example, the difference between the first performance (thickness) data of the first process run and the target performance (thickness) data is one angstrom. A threshold criteria of the criteria with respect to the target performance data could be being within +2 angstroms of the target thickness (20 angstroms). In such a case, the performance data of the second substrate that was a product of the second process run of the process recipe satisfies the criteria. The second process parameter values are sufficiently tuned to generate the target output. In some embodiments, the second process parameters whose output satisfies the criteria are saved as final process parameters for use in manufacturing.

However, if the performance data of the second substrate does not meet the criteria with respect to the target performance data, dynamic controller 150 can again determine updated process parameter values (e.g., third process parameter values) based on the second data set. In some embodiments, the second data set includes the second process parameter values, the second performance data from the second process run using the second process parameter values on the second substrate, and target performance data of the process recipe. Responsive to determining that the second performance data does not satisfy the one or more criteria with respect to the target performance data, dynamic controller 150 can process the second data set to determine third process parameter values for the process parameters. In some embodiments, the third process parameter values differ from the second process parameter values for at least one process parameter. In other words, the dynamic controller does not necessarily change all of the process parameter values from one iteration to the next.

After receiving the second process parameter values the control coefficients of dynamic controller 150, can be adjusted based on second predicted performance data (e.g., generated using the second process parameter values) and the actual performance data (e.g., generated by running the process using the second process parameter values).

In some embodiments, the process of updating the process parameter values (e.g., to determine second process parameter values, third process parameter values, and so on) and determining if the updated process parameter values produce a substrate having performance data that matches the target performance data can be iterative. The process can be repeated until the performance data of a substrate substantially algins with the target performance data (e.g., satisfies one or more criteria).

In some embodiments, the dynamic controller 150 receives a selection of one or more process parameters that are to be adjustable. In some embodiments, a data set can include one or more constraints for process parameter values of one or more process parameters for the process recipe. The one or more constraints can indicate at least one of a) which process parameter values are adjustable, b) maximum permitted process parameter values for the one or more process parameters, or c) minimum permitted process parameter vales for the one or more process parameters.

The selection of the one or more process parameters that are to be adjustable can be based on user input. For example, a process recipe can include 50 process parameters. However, a user can select 10 (or some other subset) of the 50 process parameters that dynamic controller 150 can adjust to achieve the target output. In some embodiments, certain process parameters for a process recipe can have higher impact on critical features (e.g., target feature, critical dimensions, etc.) of the manufactured substrate. A process engineer (e.g., a user) might choose to allow the dynamic controller 150 to adjust a subset of the process parameters of a process recipe to achieve a target output because focusing on the higher impact variables can help to optimize process efficiency and effectiveness without introducing unnecessary complexity. In some embodiments, by selectively adjusting selected process parameters, dynamic controller 150 can make adjustment to the selected process parameter values to achieve the target output while minimizing disruptions to other aspects of the production process.

The maximum permitted process parameter values for the one or more process parameters, or the minimum permitted process parameter vales for the one or more process parameters can also be based on user input. In some embodiments, parameters of a process recipe can be maintained within maximum or minimum limits to ensure operational safety, preserve product quality, prevent equipment damage, and optimize the efficiency of the process.

In some embodiments, process parameter values for non-selected process parameters are not adjustable. In other words, for the non-selected process parameters the second process parameter values may be the same as the first process parameter values (e.g., dynamic controller 150 does not adjust non-selected process parameters during each iteration). Conversely, for the one or more selected process parameters the second process parameter values, for example, differ from the first process parameter values (e.g., dynamic controller 150 changes at least one of the selected process parameter values from the first data set to the second data set).

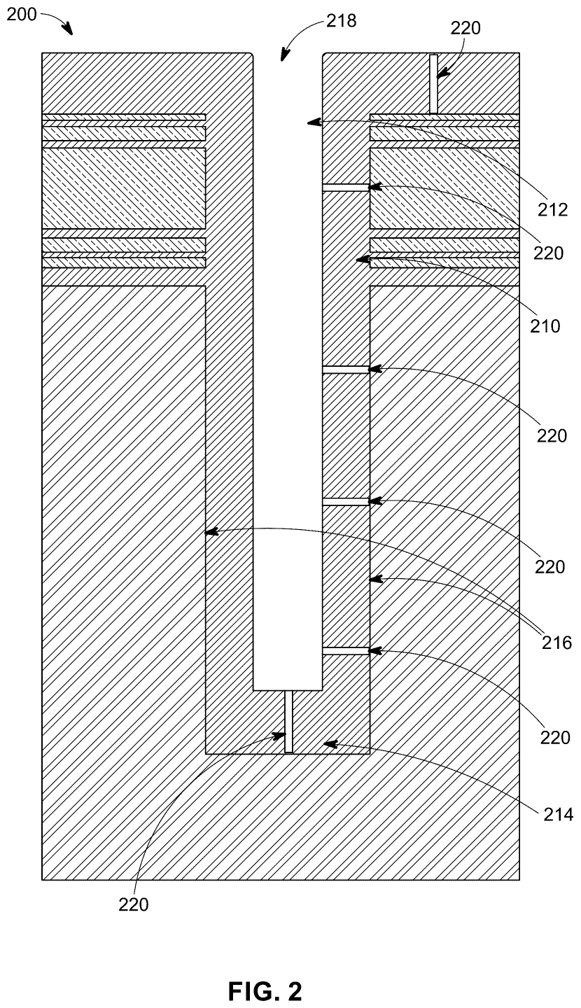

FIG. 2 is an example of metrology and performance data of a substrate, according to some embodiments.

In some embodiments, a SEM image 200 can be taken of a processed substrate. For example, a process recipe can be performed on a substrate and following the process recipe, metrology data of the substrate is collected. The metrology data of the substrate can be a microscopy image. Microscopy images may include images captured using optical techniques, electron-based techniques (e.g., scanning electron microscope (SEM) images, transmission electron microscope (TEM) images, etc.) or the like. Microscopy images can be of a cross section of a feature of the substrate in some embodiments.

Microscopy images such as SEM images can depict features of substrates and can be used to generate performance data of a substrate. For example, microscopy image 200 depicts a trench 212 and insulating film 210.

In some embodiments, plasma material processing involves using an electromagnetic field to ionize gases to generate plasma within a process chamber. Plasma material processing can be employed to etch and remove materials from surfaces of semiconductor substrates (e.g., using a plasma). The depth and rate of etching on a substrate are determined by many process parameters. These process parameter include, for example, the power of the radio frequency (RF) source energizing the electromagnetic field, the pressure within the chamber, the type of gas utilized, RF voltage bias, gas flow rate, the specific geometry of the chamber, etc. Precise control of process parameters can help to create features (e.g., trench 212) on the substrate, which form the semiconductor device structure.

Following the etching phase, a gap-filling process may be used to deposit an insulating film 210 on a bottom 214 and sidewalls 216 of etched trench 212. This gap-filling process can be performed via chemical vapor deposition (CVD) methods or atomic layer deposition (ALD) processes utilizing plasma in embodiments. A significant challenge within this phase is limiting void formation, a common issue where the insulating film prematurely accumulates at a trench entrance 218 or along sidewalls 216, effectively preventing uniform deposition to the bottom 214 of the trench.

Metrology of trench 212 can be SEM image 200. SEM image 200 can be used to generate performance data and can include measurements of the width, depth, and/or aspect ratios of trench 212 and/or the insulating film 210. In some embodiments, a dynamic controller can be used to refine process parameter values of process parameters of a process recipe used to fabricate trench 212 and insulation film 210 (e.g., of an etch recipe and/or a gap-fill recipe).

In some embodiments, critical dimensions of trench 212 and insulation film 210 can be measured at measurement points 220. In some embodiments, such measurements are performance data of the substrate and the process parameters values of the process parameters of the process recipe. In some embodiments, target performance data can include target measurements at measurement points 220. For example, a target thickness of insulation film 210 at measurement points 220 can be target performance data of a substrate and process parameters values of process parameters of the process recipe.

In some embodiments, a machine learning model may be trained to process a microscopy image such as microscopy image 200 to segment the microscopy image (e.g., into various layers, features, etc.) and/or to automatically generate measurements of one or more features (e.g., of critical dimensions) such as at measurement points 220. The machine learning model may be, for example, a convolutional neural network trained to perform segmentation (e.g., instance segmentation or semantic segmentation) and/or to generate measurements. In some embodiments, a second machine learning model or image processing algorithms are used to generate measurements for a segmented microscopy image.

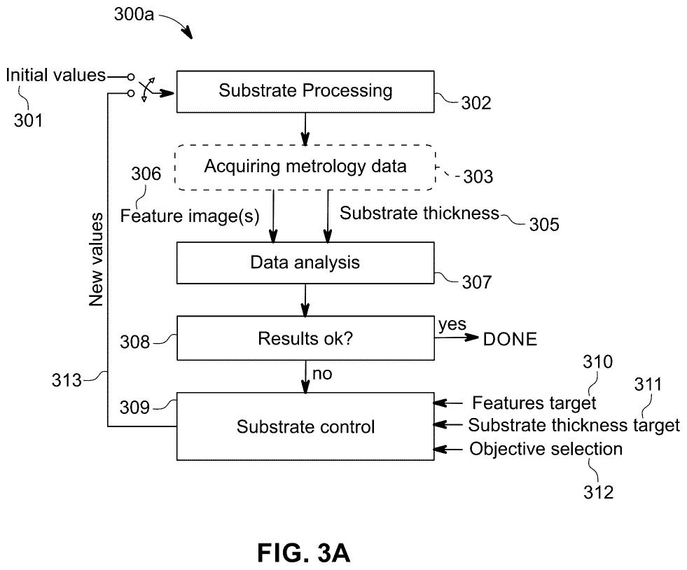

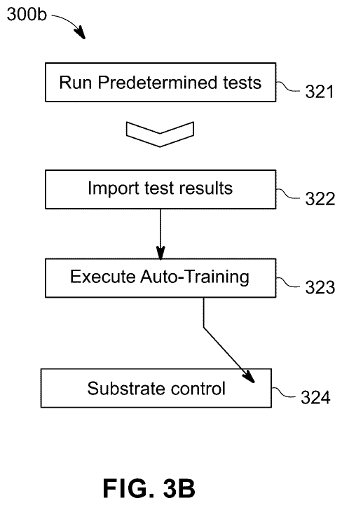

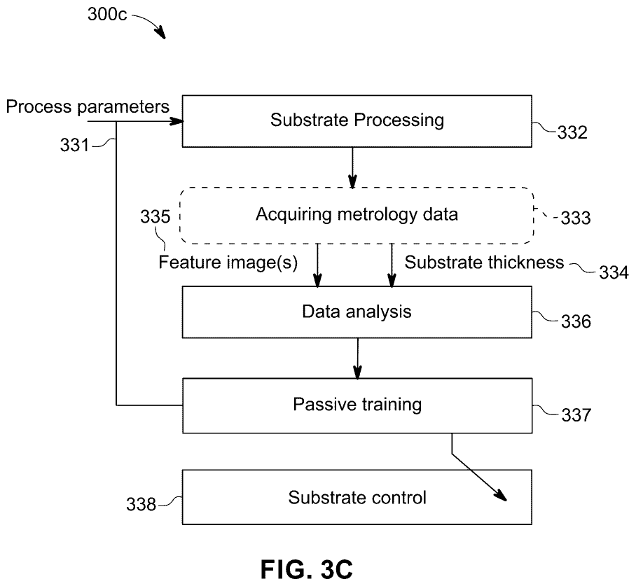

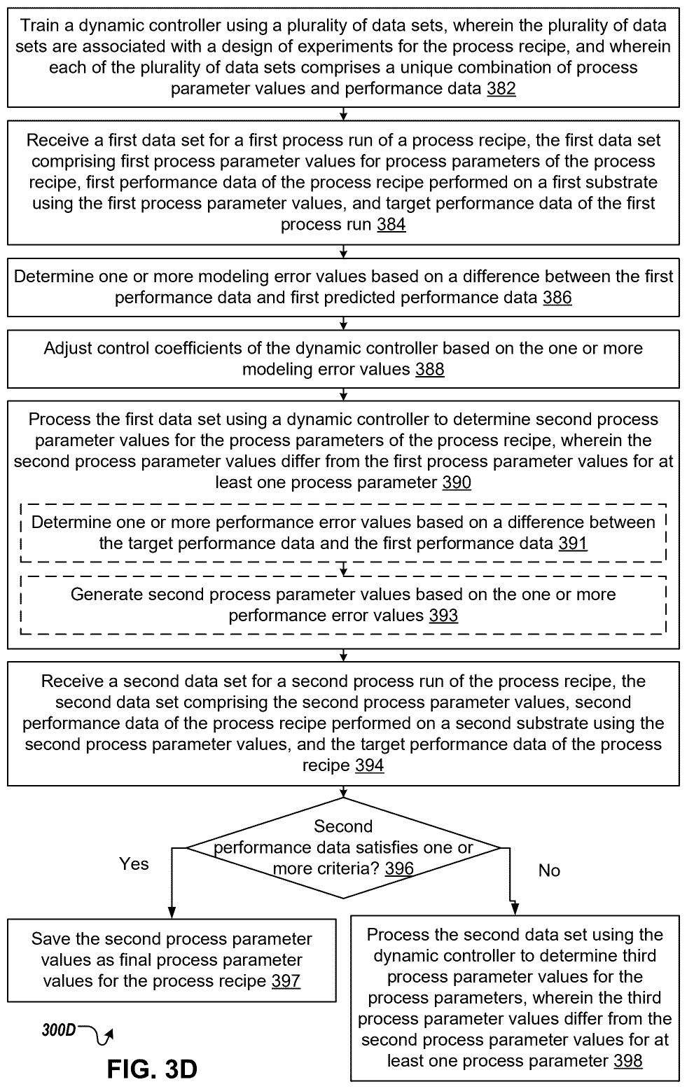

FIG. 3A is a flow diagram of a method 300A associated with dynamic process control for process recipe design, according to certain embodiments. Method 300A may be performed by processing logic, which may include hardware, software, or a combination thereof. In embodiments, method 300A is performed using a dynamic controller, such as dynamic controller 152 of FIG. 1.

The dynamic controller can be designed to achieve multiple target outcomes. For example, the dynamic controller can adjust process parameter values to control insulating film distribution across trenches (e.g., thickness of insulating film 210 across trench 212) and/or control of overall substrate thickness (e.g., overall thickness of one or more layers on the substrate). In some embodiments, different objectives of the dynamic controller can be user selectable, to provide the user the ability to target one or more objectives depending on the manufacturing objectives. In some embodiments, a substrate may be a wafer, a display panel, or other substrate.

The process of using the dynamic controller to refine process parameter values of a recipe may be iterative. Following a substrate process recipe, after substrate processing 302 is complete, metrology data acquisition 303 may be performed, and the acquired metrology data (e.g., performance data) are analyzed by the dynamic controller at block 307. Operation 303 of acquiring metrology data may include generating one or more images 306 (e.g., SEM images, optical images, etc.), measuring one or more features of the images, and/or measuring a substrate or film thickness 305 (e.g., using reflectometry or other optical metrology technique) of the substrate. Data analysis 307 may include comparing the obtained metrology data to target performance parameters (e.g., target thickness, target critical dimensions, etc.).

At block 308, processing logic may determine whether the recipe results are acceptable. The results may be acceptable, for example, if the metrology data (e.g., performance data) varies from target performance data by less than a threshold amount.

If at block 308 the performance data is satisfactory (e.g., satisfying one or more criteria) the iteration of method 300A stops as the process of using the dynamic controller to refine process parameter values of the process recipe is complete and the manufacturing system is ready for production. Otherwise, if the performance data is not yet satisfactory (e.g., not satisfying one or more criteria), the method proceeds to block 309. At block 309, the process of using the dynamic controller to refine process parameter values of the process recipe is repeated to generate a new set of process parameter values for the process parameters, and the whole process repeats using the a new set of values. In embodiments, one or more performance targets (e.g., features target 310 and substrate thickness target 311) and an objective selection 312 may be input into the dynamic controller to generate new process parameter values 313. The new process parameter values 313 may be used to repeat substrate processing 302 for a new substrate to repeat the operations of blocks 302-308.

In some embodiments, objective selection 312 can refer to a user selecting a single performance objective within a pool of objectives. For example, performance objectives can include feature control 310, substrate thickness 311, etc. In some embodiments, objective selection 312 can refer to a user selecting different weights to apply to multiple performance objectives to be achieved concurrently. For example, the weights can represent a measure of the priority (or importance) associated with the corresponding performance objectives. In some embodiments, objective selection 312 can refer to a user selecting constraint objectives, which moderate, confine or skew the adjustments of the process parameters towards a specific rate of change, process parameter space, or direction, respectively.

In some embodiments, the acquisition of metrology data may be performed outside of a process chamber. In some embodiments, the other parts of the process can be performed within the process chamber. In some embodiments, the acquisition of metrology data can also be performed at the process chamber where onboard metrology equipment is a part of the process chamber itself.

In one embodiment, outside inputs to method 300A are the initial values 301 of the process parameters, the target performance parameters 310 providing quantitative measures of the target outlook of substrate features, the target 311 corresponding to the target thickness across the substrate, and the objective selection 312 which aims to provide a user with the choice of control objective. All such inputs are generally constant in embodiments, in the sense that they represent the configuration itself of the iterative process of method 300A. As such, such inputs are to be provided once during the first iteration of method 300A, and are not further provided again for subsequent iterations unless a configuration change is to be implemented.

Discussing method 300A in greater detail, the dynamic controller receives initial values 301 of the process parameters, the target performance data (e.g., represented by quantitative measures of the target substrate features such as features target 310 and substrate thickness target 311), and a selection of adjustable process parameters which provide the user with the choice of which process parameters to adjust to achieve the target output (e.g., objective selection 312). In some embodiments, such inputs can be provided once during the first iteration of method 300A. The initial values 301, target performance data (e.g., features target 301, substrate thickness target 311) and/or objective selection 312 may not be provided again for subsequent iterations unless a configuration change is to be performed.

Examples of process parameters whose values can be adjusted by the dynamic controller include substrate gap, chamber pressure, RF power, RF voltage bias, gas flows, pedestal heater temperature, faceplate temperature, etc. Depending on process recipe being run within the process chamber, each process parameter may be varied throughout the process recipe, or may be held constant throughout the entire process recipe. In some embodiments, the initial set of process parameter values can represent the set of values of the process parameters at distinct points throughout the process recipe. For example, if chamber pressure is to be optimized at two instances during the process recipe, the initial set of process parameter values can include the two initial values of chamber pressure at the two instances.

In some embodiments, the set of initial values can be a starting point for process control. Throughout the iteration process of method 300A, the aim of the dynamic controller is to determine a new set of process parameter values that achieves target metrology data of a processed substrate and/or target performance data of the substrate (e.g., that allows the regulation of the feature images 306 and substrate thickness 305 to the features target 310 and substrate thickness target 311, respectively). In some embodiments, the initial set of process parameter values 301 can be determined by a user based on subject matter expertise, may be derived via a first-principle model of the system, may be a set of values that are utilized by other process recipes (e.g., similar recipes), or may be determined from a DOE. In some embodiments, the initial set of process parameter values can be derived via a first-principle model of the system (e.g., a software model of a physical system (physical model)).

The initial set of process parameter values 301 is used to configure the first iteration of the process recipe (e.g., substrate processing 302). In subsequent iterations of the process recipe, the recipe uses the new set of process parameter values (e.g., new values 313) determined by the dynamic controller.

Once the initial set of process parameter values are provided to the dynamic controller, the first substrate can be processed according to the process recipe at block 302. At the end of the process recipe, the performance data of the processed substrate can be retrieved using a metrology system at block 303. The metrology system can be located in-situ (at the tool or process chamber) or can be separate from the tool or process chamber.

The performance data retrieved by the metrology system can be one or more images (e.g., SEM images or feature images 306) and/or other measurements of the substrate that depict the results of the process recipe on a cross-section of the substrate and/or taken of a surface of the substrate. The performance data retrieved by the metrology system can include, for example, thicknesses measured at several locations across the substrate surface (e.g., substrate thickness 305). In some embodiments, metrology data relevant to the target performance data is collected. For example, if feature dimensions and substrate thickness are both part of the target performance data then a SEM image of a cross section of the feature and substrate thickness measurements can be collected. For instance, if the substrate control objective 312 is to solely regulate the substrate thickness to the target 311, substrate thickness data 305 are utilized by the subsequent steps depicted in methods 300B-D. Similarly, if the substrate control objective 312 is to solely regulate the substrate features to the target 310, the substrate feature image(s) 306 are retrieved and utilized by the subsequent steps depicted in methods 300B-D. Otherwise, if both the substrate control objectives are selected within 312, both data sets 305 and 306 are utilized.

Once metrology data (e.g., feature images 306, substrate thickness 305) is collected it can be analyzed at block 307. For example, SEM images can be analyzed to identify the characteristics of the features. Such characteristics can be converted into metadata (e.g., numerical representations of image data). For example, the metadata may include dimensions of the insulating film 210 at one or more of measurement locations 220 the feature trench 212, critical dimensions at one or more measurement locations 220, etc. In some embodiments, the metadata may be representative of other characteristics of the manufactured substrate and/or its feature(s).

For substrate thickness data 305, sometimes the goal is to pinpoint and remove any errors or artifacts caused by measurement inaccuracies and/or noise. Other times, the analysis focuses on creating statistical summaries to evaluate how well the substrate processing is performing.

In some embodiments, the results of the performance data analysis 307 can be displayed to the user at a client device to provide information about the progress of the process control, and/or to give the user a chance to change settings or intervene. In some embodiments, such high-level information can be displayed on a screen at the manufacturing tool (e.g., process chamber) itself.

In some embodiments, a quality assessment is performed at block 308 to determine if an additional refinement of the process parameter values for a process recipe is to be performed. If the process results (e.g., performance data) are far from the corresponding target (e.g., difference between performance data and target performance data is greater than a threshold difference), then a subsequent iteration of the dynamic control can be performed. Otherwise, if the process results meet the target, the iterative process can be stopped as the goal of determining the process parameter values that achieve the target performance has been attained. In some embodiments, the values of the process parameters last used during the substrate processing 302 can become an optimal value set (e.g., the final process parameter values) for a process recipe. In some embodiments, if the process results are at the target during the first iteration the set of initial process parameter values 301 can be the final process parameter values.

In some embodiments, the dynamic controller performs a comparison between metadata of the performance data and corresponding target values of the target performance data. Any significant difference (e.g., difference that exceeds a difference threshold) between the metadata of the performance data and corresponding target values of the target performance data triggers a subsequent iteration to compute new values of the process parameters. In some embodiments, the dynamic controller embeds the data representing the correlation between changes of process parameters and corresponding effect on the performance data in the dynamic controller for making the calculation of the new set of process parameter values possible. In embodiments, correlation data (e.g., of the correlation between changes to the process parameter values and the performance data) does not use a high accuracy threshold because the dynamic controller can produce incremental adjustments based on each iteration. In some embodiments, such correlation data is subject to adaptation (e.g., the correlation data varies with the controller coefficients as they are adjusted).

Once determined, the final process parameter values of the process parameters of the process recipe can be applied to the process recipe automatically or made available for a user to review. In the former case, the adjustments to the process parameter values may be automatically applied within the process recipe. In the latter case, the adjustments to the process parameter values may be produced and displayed (e.g., at a client device), and the dynamic controller waits for the user to manually apply them to the process recipe.

In some embodiments, the dynamic controller can be configured with additional inputs corresponding to minimum and maximum values allowed for each of the process parameters. In some embodiments, this allows a process engineer to retain control of the range values of the process parameters, so that the values of process parameters remain within feasible and/or safe boundaries.

FIG. 3B is a flow diagram of a method 300B associated with process control for semiconductor processing, according to certain embodiments.

In some embodiments, training the dynamic controller refers to providing the dynamic controller sufficient data for the dynamic controller to identify and extrapolate a correlation between changes of process parameter values and corresponding effects to the performance data (e.g., represented by numerical metadata). The correlation data may be embedded in the dynamic controller and enables the dynamic controller to compute meaningful adjustments of the process parameter values. The correlation data can be embedded within the configuration of the tunable parameters (e.g., control coefficients) of the dynamic controller.

In some embodiments, the correlation data can be actively obtained through active training of the dynamic controller, each of which is explained below. In some embodiments, the correlation data can be acquired through passive training of the dynamic controller as described in FIG. 3C. In either case, the training can be performed in-situ. In some embodiments, performing the dynamic controller training directly in-situ as opposed to using data generated by an ad-hoc model 1) provides data for training that is data from the actual system and is more accurate than any given model and 2) helps to minimize time and the use of additional human resources.

Referring to FIG. 3B, at block 321, active training of the dynamic controller includes executing predetermined (e.g., ad-hoc) tests (e.g., via a design of experiments (DOE)) specifically designed to quantify the correlation between corresponding variations of the process parameter values and the performance data of a substrate (e.g., substrate metadata). Each test within the predetermined tests includes 1) executing the substrate process recipe with a specific set of process parameters values, and 2) acquiring metrology data of the substrate processed using specific set of process parameters values. In embodiments, a DOE may be generated that includes multiple different test runs, each including a different set of process parameter values. The process parameter vales for the different test runs may be selected to enable correlations between certain process parameter values and performance data to be made. For example, the process parameter values can be imported by the user,

When the predetermined tests are completed, at block 322 the corresponding metrology data (performance data, test results, etc.) can be imported (e.g., uploaded) to the dynamic controller on the tool and/or process chamber.

At block 323, the metrology data (performance data) can be used by the dynamic controller to execute the auto-training task (e.g., to determine an appropriate value for the substrate control configuration). In some embodiments, appropriate values (e.g., control coefficients) can be determined for the dynamic controller configuration. Once the dynamic controller has been configured, method 300A may be performed using the initially trained dynamic controller to determine optimal process parameter values for a process recipe. The dynamic controller may be further trained with each iteration of execution of method 300A (e.g., passive training) in embodiments.

In some embodiments, the auto-training task refers to the task performed automatically by the controller to adjust its own coefficients. Adjusting the coefficients includes selecting coefficients to embed information about the correlation between the metrology data (performance data) and the process parameters utilized to generate the metrology data. The information about the correlation between the metrology data and the process parameters can be embedded in the coefficients through the minimization of a cost index embedding (e.g.) the difference between the actual output and modeled output of the process.

At block 324, the updated values (e.g., control coefficients) for the computation of the next process parameters are populated in the wafer control.

In some embodiments, the predetermined tests can be performed in a batch, as no one test depends on the results of other tests in some embodiments. This provides added efficiency to the active training of the dynamic controller because it allows the active training to be entirely performed in, for example, a single day.

FIG. 3C is a flow diagram of a method 300C associated with process control for semiconductor processing, according to certain embodiments.

In embodiments, method 300C may be performed for passive training of a dynamic controller. Passive training of the dynamic controller does not make use of predetermined tests. Passive training of the dynamic controller includes updating the configuration of the dynamic controller (e.g., control coefficients) during the dynamic control process iterations described above (e.g., with reference to FIG. 3A).

At block 337, the passive training algorithm uses the currently utilized process parameters and the corresponding resulting metadata to automatically update the configuration of the substrate control at block 338. Passive training of dynamic controller uses the current process parameter values 331 at block 332 during substrate processing.

For example, during passive training, appropriate values (e.g., control coefficients) can be determined for the dynamic controller configuration. Once the dynamic controller has been configured (e.g., after each iteration), method 300A may be performed using the iteratively trained dynamic controller to determine optimal process parameter values for a process recipe and the dynamic controller is further trained with each iteration of execution of method 300A. In some embodiments, the process parameter values 331 are retrieved from memory (where they are stored after being generated).

In some embodiments, the passive training task refers to the task performed automatically by the controller to adjust its own coefficients iteratively following each iteration of the process recipe using updated process parameters. Adjusting the coefficients includes selecting coefficients to embed information about the correlation between the metrology data (performance data) and the process parameters utilized to produce such metrology data. The information about the correlation between the metrology data and the process parameters of each iteration can be embedded in the coefficients through the minimization of a cost index embedding (e.g.) the difference between the actual output and modeled output of the process).

At block 333, metrology data corresponding to the substrate processing with the process parameters is generated. For example, feature images 335 and substrate thickness measurements 334 of a processed substrate may be generated.

At block 336, the metrology data is analyzed. The corresponding metrology data (e.g., performance data) can be used at block 337 to execute passive training of the dynamic controller.

At block 338, appropriate values (e.g., control coefficients) can be populated in the dynamic controller configuration (e.g., coefficients are automatically populated to update the configuration of the dynamic controller with each iteration).

The passive training methodology does not rely on predetermined tests (e.g., predetermined tests 321 of FIG. 3B) to update the substrate control configuration during the substrate regulation process. In instances where the passive training method is employed, the following components are involved. The passive training algorithm of block 337 utilizes the currently process parameters 331 and their corresponding metadata to automatically update the configuration of the substrate control 338. The passive training methodology can optimize the process recipe by learning from previous iterations without relying on predetermined tests.

In some embodiments, passive training of the dynamic controller can be well suited for cases where the response of the system to the same changes in one or more parameter values has only slightly changed over time. In such cases, the dynamic controller may use a higher number of iterations to attain an optimal process parameter value set (e.g., final process parameter values). In such cases, passive training of the dynamic controller may be utilized in conjunction with the dynamic control of the process parameter values, helping to decrease the number of iterations and removing the need to execute active training of the dynamic controller.

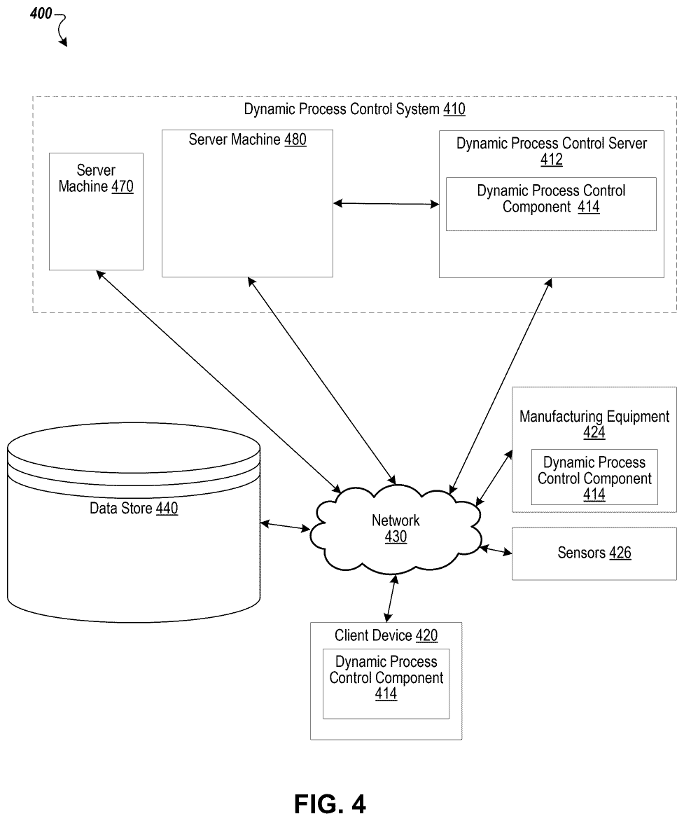

FIG. 3D is a flow diagram of a method 300D associated with process control for semiconductor processing, according to certain embodiments. In some embodiments, method 300D is performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In one implementation, method 300D can be performed by a computer system, such as the one shown in FIG. 4. In other or similar implementations, one or more operations of method 300D can be performed by one or more other machines not depicted in the figures. In some embodiments, method 300D is performed by client device 420 (e.g., dynamic process control component 414) and/or dynamic process control system 410. In some embodiments, a non-transitory storage medium stores instructions that when executed by a processing device (e.g., of dynamic process control system 410, of server machine 480, of dynamic process control server 412, of client device 420, etc.), cause the processing device to perform method 300D.

For simplicity of explanation, method 300D is depicted and described as a series of operations. However, operations in accordance with this disclosure can occur in various orders and/or concurrently and with other operations not presented and described herein. Furthermore, in some embodiments, not all illustrated operations are performed to implement method 300D in accordance with the disclosed subject matter. In addition, those skilled in the art will understand and appreciate that method 300D could alternatively be represented as a series of interrelated states via a state diagram or events.

Referring to FIG. 3D, in some embodiments, at block 382 the processing logic implementing the method 300D trains a dynamic controller using a plurality of data sets. In some embodiments, the plurality of data sets are associated with a design of experiments (DOE) for a process recipe. Each of the plurality of data sets includes a unique combination of process parameter values and performance data. In some embodiments, the dynamic controller is a multiple input-multiple output (MIMO) controller.

In some embodiments, control coefficient values can be determined for the dynamic controller configuration by selecting coefficients to embed information about the plurality of data sets. For example, the correlation between the performance data and the corresponding process parameters can be embedded in the coefficients through the minimization of a cost index embedding (e.g.) the difference between the actual output and modeled output of the process. In some embodiments, the plurality of data sets can be provided to the dynamic controller by a user during an active training of the dynamic controller (e.g., as described with regard to FIG. 3B).

In some embodiments, the first performance data and the second performance data includes one or more measurements from metrology data of a processed substrate that indicate one or more critical dimensions. In some embodiments, the processing logic can further process the metrology data using a trained machine learning model to generate at least one of the first performance data or the second performance data.

At block 384, the processing logic receives a first data set for a first process run of a process recipe (optionally after initial training of the dynamic controller based on a DOI), the first data set including first process parameter values for process parameters of the process recipe, first performance data of the process recipe performed on a first substrate using the first process parameter values, and target performance data of the first process run.

In some embodiments, the first data set further includes one or more constraints for process parameter values of one or more process parameters for the process recipe. The one or more constraints can indicate at least one of a) which process parameter values are adjustable, b) maximum permitted process parameter values for the one or more process parameters, or c) minimum permitted process parameter vales for the one or more process parameters.

At block 386, the processing logic determines one or more modeling error values based on a difference between the first performance data and first predicted performance data. In some embodiments, the first predicted performance data can be derived via a first-principle model of the system (e.g., a software model of a physical system).

In some embodiments, the determining the one or more modeling error values based on the difference between the first performance data and the first predicted performance data includes determining a direction and magnitude of change in the difference between the target performance data and the first performance data.

Predicted performance data refers to predicted outcomes of a process recipe, for example, as predicted by a physics-based model. This data can include simulated images (such as SEM or feature images) and other predicted measurements, depicting the expected performance data of a substrate that has undergone the recipe. Predicted performance data, for example, can be one or more predicted images (e.g., SEM images or feature images generated by a prediction model) and/or other predicted measurements of the substrate that depict the results of the process recipe on a cross-section of the substrate and/or taken of a surface of the substrate. A criteria can be, for example, dimensional accuracy of features (ensuring they meet specific width and depth specifications), surface roughness (where the roughness should not exceed predefined limits), uniformity of material deposition (ensuring consistent thickness across the substrate), electrical conductivity of the layers (meeting specific resistance or conductance standards), etc.

At block 388, the processing logic adjusts control coefficients of the dynamic controller based on the one or more modeling error values. In some embodiments, the one or more modeling error values are one or more differences between the first performance data and the first predicted performance data.

In some embodiments, during passive training, updated or adjusted control coefficients can be determined for the dynamic controller configuration. In some embodiments, process parameter values are retrieved from memory (where they are stored after being generated). This passive training task can refer to the task performed automatically by the dynamic controller to adjust its own coefficients iteratively following each iteration of the process recipe using updated process parameters. Adjusting the coefficients includes selecting coefficients to embed information about the correlation between the performance data and corresponding process parameters of each iteration-. The information about the correlation between the performance data and corresponding process parameters of each iteration can be embedded in the coefficients through the minimization of a cost index embedding (e.g., the difference between the real and modeled output of the process).

At block 390, the processing logic processes the first data set using the dynamic controller to determine second process parameter values for the process parameters of the process recipe. The second process parameter values differ from the first process parameter values for at least one process parameter. In some embodiments, the first data set can be processed in conjunction with predicted performance data.

At block 391, the processing logic determines one or more performance error values based on a difference between the target performance data and the first performance data.

At block 393, the processing logic generates second process parameter values based on the one or more performance error values.

In some embodiments, the determining the one or more performance error values based on the difference between the target performance data and the first performance data includes determining a direction and magnitude of change in the difference between the first performance data and the first predicted performance data.

In some embodiments, the processing logic can receive a selection of one or more process parameters that are to be adjusted, where process parameter values for non-selected process parameters are not adjustable. In some embodiments, for the one or more selected process parameters the second process parameter values differ from the first process parameter values, and for the non-selected process parameters the second process parameter values are the same as the first process parameter values.

A second process run may be performed on a second substrate using the second process parameter values for a process recipe. Second performance data may then be collected for the substrate processed using the second process parameter values.

At block 394, the processing logic receives a second data set for the second process run of the process recipe, the second data set including the second process parameter values, the second performance data of the process recipe performed on the second substrate using the second process parameter values, and the target performance data of the process recipe.

At block 396, processing logic determines a difference between the second performance data and the target performance data (e.g., repeats the operations of block 386). Processing logic may then compare the difference to one or more criteria with respect to the target performance data. Performance data can be one or more images (e.g., SEM images or feature images) and/or other measurements of the substrate that depict the results of the process recipe on a cross-section of the substrate and/or taken of a surface of the substrate. A criteria can be, for example, dimensional accuracy of features (ensuring they meet specific width and depth specifications), surface roughness (where the roughness should not exceed predefined limits), uniformity of material deposition (ensuring consistent thickness across the substrate), electrical conductivity of the layers (meeting specific resistance or conductance standards), etc. For example, the processing logic determines the differences between the actual performance data of the processed substrate (e.g., the second performance data) and the predefined target performance data. The processing logic assesses how closely the second performance data from the processed substrate aligns with the target performance data, using predefined criteria to evaluate if the differences are within acceptable thresholds. For example, criteria can include deposition thickness, where if the actual thickness (e.g., of the second performance data) deviates from the target by less than a specified threshold value, the second performance data satisfies the criteria. In some embodiments, the one or more criteria can be for example, critical dimension uniformity, film thickness uniformity, particle counts, surface roughness uniformity, etc. If the one or more criteria are satisfied, the method continues to block 397. If the one or more criteria are not satisfied, the method continues to block 398.

At block 397, the processing logic, responsive to determining that the second performance data satisfies one or more criteria with respect to the target performance data, saves the second process parameter values as final process parameter values for the process recipe. Once the final process parameter values are determined for a process recipe, the process recipe may be used to process product substrates (e.g., substrates on which electronic devices are being formed). One or more process chambers may execute the process recipe having the final process parameter values for a plurality of product substrates. The processed substrates may then have third performance data that satisfies the one or more criteria with respect to the target performance data. The processed substrates may meet specifications associated with the process recipe and/or with the post-processed substrate, for example.

At block 398, the processing logic, responsive to determining that the second performance data does not satisfy the one or more criteria with respect to the target performance data, processes the second data set using the dynamic controller to determine third process parameter values for the process parameters, where the third process parameter values differ from the second process parameter values for at least one process parameter.

In some embodiments, at most three process runs are performed, each being based on a unique set of process parameter values output by the dynamic controller, before the final process parameter values for the process recipe are determined. In some use cases, at most four process runs are performed, at most five process runs are performed, or at most six process runs are performed, and so on, each process run being based on a unique set of process parameter values output by the dynamic controller, before the final process parameter values for the process recipe are determined.

FIG. 4 is a block diagram illustrating an exemplary system 400 (exemplary system architecture), according to certain embodiments. The system 400 can include a client device 420, manufacturing equipment 424, sensors 426, a dynamic process control system 410, and a data store 440. In some embodiments, the dynamic process control system 410 includes a dynamic process control server 412. In some embodiments, the dynamic process control system 410 further includes server machines 470 and 480.

In some embodiments, one or more of the client device 420, manufacturing equipment 424, sensors 426, dynamic process control server 412, data store 440, server machine 470, and/or server machine 480 are coupled to each other via a network 430 for performing dynamic process control. In some embodiments, network 430 is a public network that provides client device 420 with access to the dynamic process control server 412, data store 440, and other publicly available computing devices. In some embodiments, network 430 is a private network that provides client device 420 access to manufacturing equipment 424, sensors 426, data store 440, and other privately available computing devices. In some embodiments, network 430 includes one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

Manufacturing equipment 424 can produce products, such as substrates, wafers, semiconductors, electronic devices, etc., following a recipe or a process. Manufacturing equipment 424 can include multiple process chambers. Each process chamber can include manufacturing tools. For example, process chambers can include heaters for processes requiring precise temperature control like thermal oxidation or chemical vapor deposition, with adjustable temperature settings; chillers to maintain or rapidly reduce temperature in sensitive processes like photolithography; gas flow controllers to manage the flow rates and types of gases essential for deposition and etching processes; RF generators for plasma-enhanced processes such as plasma etching or ion implantation, with settings to control power level and frequency; vacuum pumps to maintain necessary vacuum conditions, with adjustable vacuum levels and pump speeds; deposition sources for materials in physical vapor deposition (PVD) or chemical precursors in chemical vapor deposition (CVD), with settings for material feed rate and energy input; and electrostatic chucks (ESC) to hold and electrically bias the wafer during processes, with adjustable temperature and voltage settings. Each piece of equipment can be equipped with its own controllable parameter settings that allow for adjustments needed to meet strict product specifications and ensure process repeatability and uniformity.

For example, such parameter settings of a process chamber can be optimized (e.g., by adjusting process parameter values) to achieve a target output of the process recipe. Process chambers of manufacturing equipment 424 can be used to perform process recipes for producing substrates. Each process recipe includes process parameters, such as temperature settings, gas flow rates, pressure settings, plasma process parameter values, and voltage levels, etc. which can be optimized to achieve target outputs. These process parameter values can be adjusted to help ensure the quality and consistency of the manufactured products. Optimizing these process parameter values can help to maintaining high production standards and meet product specifications.

In some embodiments, a process chamber can include sensors (e.g., sensors 426) configured to generate in-situ sensor measurement values during a process performed at process chamber. In some embodiments, the sensors can be configured to generate a sensor measurement values during particular instances of a process operation.

Manufacturing equipment 424, client device 420 and/or dynamic process control server 412 can be include a dynamic process control component 414. The dynamic process control component 414 can, for example, be included in a tool or process chamber of manufacturing equipment 424. Dynamic process control component 414 can refine process parameters values of process parameters of process recipes. For example, dynamic process control component 414 can include a dynamic controller (e.g., a MIMO dynamic controller) trained to determine updated process parameter values of a process recipe based on a first data set including first process parameter values for process parameters of a first run of the process recipe, first performance data from a first process run of the process recipe, and target performance data for process recipe. The performance data from the first process run can be, for example, metrology data of a first substrate that was processed during the first process run of the process recipe (e.g., using the first process parameter values) and/or after the first process run of the process recipe. In some embodiments, metrology can be obtained in-situ (at the tool) or outside of the process chamber or tool.

Dynamic process control component 414 can determine adjustments to the first process parameters using dynamic control. For example, dynamic process control component 414 can calculate performance error values based on differences between the first performance data and the target performance data being input into a dynamic controller.

Dynamic process control component 414 can further calculate modeling error values based on differences between measured performance data and predicted performance data (e.g., based on process parameter values of a process run) and then adjust control coefficients of differential equations of the dynamic process control component 414 based on the modeling error values. After adjusting the control coefficients based on the modeling error values, the process parameter values can be updated by the dynamic process control component 414 in order to achieve target performance data. With each iteration of inputting data into the dynamic process control component 414 and updating the control coefficients and/or the process parameter values the dynamic process control component 414 can more accurately achieve updated process parameters values that achieve the target output.

In some embodiments, dynamic process control component 414 outputs updated process parameter values that are used to process a subsequent substrate (e.g., a second substrate) from which updated performance data (e.g., second performance data) is extracted. For example, a second run of the process recipe using the updated process parameter values can generate a second substrate, and performance data of the second substrate can be obtained. In some embodiments, if the performance data of the second substrate meets certain criteria with respect to the target performance data, the updated process parameter values can be saved as final process parameters for the recipe.

In some embodiments, if the performance data of the second substrate does not meet the criteria with respect to the target performance data, dynamic process control component 414 can again determine updated process parameter values based on a second data set including the updated (e.g., second) process parameter values, the performance data from the second process run using the updated process parameter values on the second substrate, and target performance data for the second process run. In some embodiments, the process of updating the process parameter values and determining if the updated values produce a substrate having performance data that matches the target performance data can be iterative, being repeated until the performance data of a substrate processed with updated process parameter values satisfies the performance criteria.

In some embodiments, dynamic process control component 414 can determine process parameter values that satisfy the criteria for a process recipe in at most three iterations. In some use cases, dynamic process control component 414 can determine process parameter values that satisfy the criteria for a process recipe in at most four iterations, at most five iterations, or at most six iterations, an so on. In embodiments, the iterations are each based on a unique set of process parameter values, which may have been output by dynamic process control component 414. The dynamic controller of the dynamic process control component may be trained with the results of each process run in embodiments. By training the dynamic controller of dynamic process control component 414 for a process recipe, process parameter value refinement can be expedited.

In some embodiments, the dynamic controller of dynamic process control component 414 can be trained prior to receiving the first data set by providing multiple data sets associated with a DOE for a process recipe. Each data set can contain unique combinations of process parameter values and corresponding performance data. By training the dynamic controller of dynamic process control component 414 on such data sets for a certain process recipe, dynamic process control component 414 makes adjustments to control coefficients, optimizing the process of refining process parameters values of process parameters of the process recipe.

In some embodiments, the data sets (e.g., first data set, second data set, and so on) and/or additional data sets generated from a DOE in order to perform initial training of the dynamic controller of dynamic process control component 414 can be stored in data store 440. In some embodiments, the data store 440 is memory (e.g., random access memory), a drive (e.g., a hard drive, a flash drive), a database system, or another type of component or device capable of storing data. In some embodiments, data store 440 includes multiple storage components (e.g., multiple drives or multiple databases) that span multiple computing devices (e.g., multiple server computers).

In some embodiments, the manufacturing equipment 424 (e.g., deposition chamber, etch chamber, and/or the like) is part of a substrate processing system (e.g., integrated processing system). The manufacturing equipment 424 includes one or more of a controller, an enclosure system (e.g., substrate carrier, front opening unified pod (FOUP), a factory interface (e.g., equipment front end module (EFEM)), a load lock, a transfer chamber, one or more process chambers, a robot arm (e.g., disposed in the transfer chamber, disposed in the front interface, etc.), and/or the like. In some embodiments, the manufacturing equipment 424 includes components of substrate processing systems.

In some embodiments, the client device 420 includes a computing device such as Personal Computers (PCs), laptops, mobile phones, smart phones, tablet computers, netbook computers, etc. In some embodiments, the client device 420 includes a dynamic process control component 414. In some embodiments, the dynamic process control component 414 is included in the dynamic process control system 410 (e.g., instead of or in addition to being included in client device 420). Client device 420 includes an operating system that can allow users to consolidate, generate, view, or edit data, provide directives to the dynamic process control system 410, etc.

In some embodiments, dynamic process control component 414 receives one or more of user input (e.g., via a graphical user Interface (GUI) displayed on the client device 420) and/or data sets for one or more process runs of a process recipe. The data sets can include process parameter values from the process recipe, performance data of substrates processed using the process parameter values, and target performance data of the process recipe (e.g., for the substrates). In some embodiments, the data sets can include process parameter values from the GUI for use during the active training of the dynamic controller and process parameter values from the memory for use during the passive training of the dynamic controller. In some embodiments, dynamic process control component 414 transmits data (e.g., process parameter values data, updated process parameters data, error values data, control coefficients data, performance data, target performance data, correlation data (e.g., of the correlation between changes to the process parameter values and the performance data), etc.) to the dynamic process control system 410, and receives updated parameter values data from the dynamic process control system 410. In some embodiments, dynamic process control component 414 transmits data (e.g., process parameter values data, updated process parameters data, error values data, control coefficients data, performance data, target performance data, correlation data (e.g., of the correlation between changes to the process parameter values and the performance data) etc.) to the dynamic process control system 410, receives updated parameter values data from the dynamic process control system 410, and outputs updated control coefficients of the dynamic controller based on calculated modeling error values (e.g., based on based on the difference between performance data and predicted performance data).

In some embodiments, the dynamic process control component 414, stores data (e.g., process parameter values data, updated process parameters data, error values data, control coefficients data, performance data, target performance data, correlation data (e.g., of the correlation between changes to the process parameter values and the performance data, etc.) in the data store 440 and the dynamic process control server 412 retrieves the data from the data store 440. In some embodiments, data store 440 can be configured to store data that is not accessible to a user of the manufacturing system. For example, one or more of process parameter values data, performance data, target performance data, correlation data, etc. may not be accessible to a user (e.g., an operator) of the manufacturing system.

In some embodiments, process parameter values data can be data representing the specific settings of some or all process parameters within a process chamber (e.g., temperature, pressure, gas flow rates, etc.) for each iteration of a recipe associated with process control by dynamic process control component 414. In some embodiments, updated process parameters data can be data representing the refined values of process parameters after adjustments have been made to optimize the process recipe toward achieving target outputs. In some embodiments, performance data can be data representing the actual results and characteristics measured from the processed products, such as dimensions, electrical properties, and material composition. In some embodiments, target performance data can be data representing the target outcomes and specifications that the process recipe aims to achieve. Additionally, modeling error values data can be data quantifying the differences between the actual performance data and the predicted performance data, which may be used to guide adjustments to control coefficients of the dynamic controller. Control coefficients data can be data detailing the values of coefficients used in the control algorithms (e.g., differential equations) of the dynamic controller of dynamic process control component 414. In some embodiments, correlation data can be data that represents the correlation between changes to the process parameter values and the performance data (e.g., magnitudes of change and direction of change).

In some embodiments, the dynamic process control server 412, server machine 470, and server machine 480 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

In some embodiments, dynamic process control system 410 further includes server machine 470 and server machine 480.

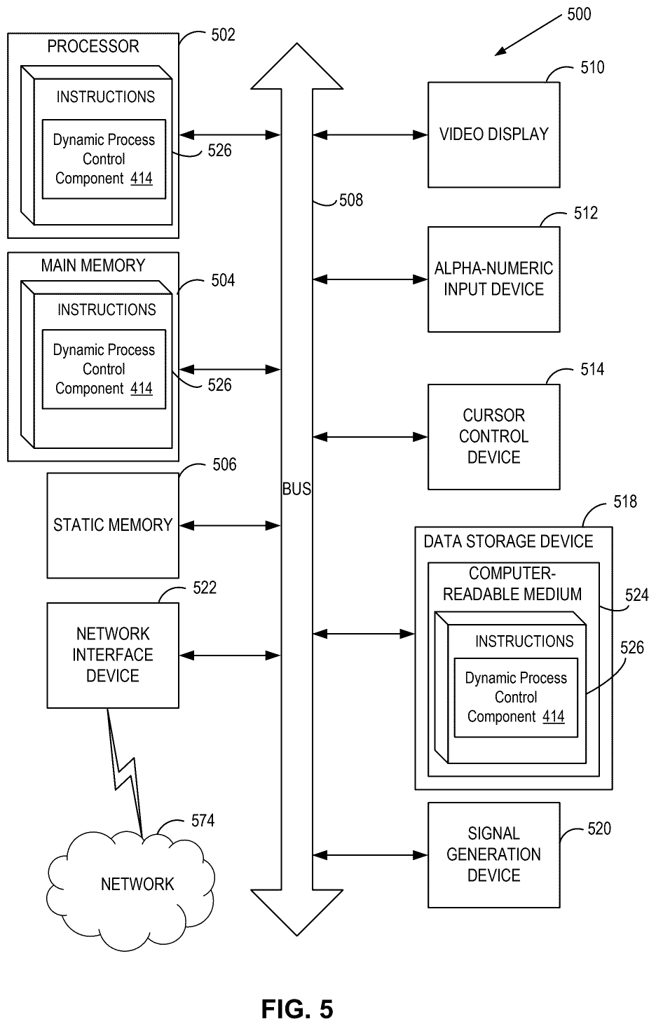

FIG. 5 is a block diagram illustrating a computer system 500, according to certain embodiments. In some embodiments, the computer system 500 is one or more of client device 420, dynamic process control system 410, server machine 470, server machine 480, dynamic process control server 412, and/or the like.

In some embodiments, computer system 500 is connected (e.g., via a network, such as a Local Area Network (LAN), an intranet, an extranet, or the Internet) to other computer systems. In some embodiments, computer system 500 operates in the capacity of a server or a client computer in a client-server environment, or as a peer computer in a peer-to-peer or distributed network environment. In some embodiments, computer system 500 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 includes a processing device 502, a volatile memory 504 (e.g., Random Access Memory (RAM)), a non-volatile memory 506 (e.g., Read-Only Memory (ROM) or Electrically-Erasable Programmable ROM (EEPROM)), and a data storage device 518, which communicate with each other via a bus 508.

In some embodiments, processing device 502 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 500 further includes a network interface device 522 (e.g., coupled to network 574). In some embodiments, computer system 500 also includes a video display unit 510 (e.g., a liquid crystal display (LCD)), an alphanumeric input device 512 (e.g., a keyboard), a cursor control device 514 (e.g., a mouse), and a signal generation device 520.

In some implementations, data storage device 518 includes a non-transitory computer-readable storage medium 524 on which store instructions 526 encoding any one or more of the methods or functions described herein, including instructions encoding components of FIG. 4 (e.g., dynamic process control component 414, etc.) and for implementing methods described herein (e.g., methods 300A-D).

In some embodiments, instructions 526 also reside, completely or partially, within volatile memory 504 and/or within processing device 502 during execution thereof by computer system 500, hence, in some embodiments, volatile memory 504 and processing device 502 also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein can be implemented by discrete hardware components or can be integrated in the functionality of other hardware components such as application specific integrated circuits (ASICS), FPGAs, DSPs or similar devices. In addition, the methods, components, and features can be implemented by firmware modules or functional circuitry within hardware devices. Further, the methods, components, and features can be implemented in any combination of hardware devices and computer program components, or in computer programs.

Unless specifically stated otherwise, terms such as “determining,” “providing,” “obtaining,” “causing,” “training,” “receiving,” “processing,” “saving,” “calculating,” “adjusting,” “identifying,” “performing,” “causing,” “accessing,” “adding,” “using,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and cannot have an ordinal meaning according to their numerical designation.

Examples described herein also relate to an apparatus for performing the methods described herein. This apparatus can be specially constructed for performing the methods described herein, or it can include a general purpose computer system selectively programmed by a computer program stored in the computer system. Such a computer program can be stored in a computer-readable tangible storage medium.

The methods and illustrative examples described herein are not inherently related to any particular computer or other apparatus. Various general purpose systems can be used in accordance with the teachings described herein, or it can prove convenient to construct more specialized apparatus to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A method, comprising:
receiving a first data set for a first process run of a process recipe, the first data set comprising first process parameter values for process parameters of the process recipe, first performance data of the process recipe performed on a first substrate using the first process parameter values, and target performance data of the process recipe;
processing the first data set using a dynamic controller to determine second process parameter values for the process parameters of the process recipe, wherein the second process parameter values differ from the first process parameter values for at least one process parameter;
receiving a second data set for a second process run of the process recipe, the second data set comprising the second process parameter values, second performance data of the process recipe performed on a second substrate using the second process parameter values, and the target performance data of the process recipe; and
responsive to determining that the second performance data satisfies one or more criteria with respect to the target performance data, saving the second process parameter values as final process parameter values for the process recipe.

2. The method of claim 1, further comprising:
responsive to determining that the second performance data does not satisfy the one or more criteria with respect to the target performance data, processing the second data set using the dynamic controller to determine third process parameter values for the process parameters, wherein the third process parameter values differ from the second process parameter values for at least one process parameter.

3. The method of claim 1, wherein for at least some use cases at most three process runs are performed, each being based on a unique set of process parameter values output by the dynamic controller, before the final process parameter values for the process recipe are determined.

4. The method of claim 1, further comprising:
prior to receiving the first data set, training the dynamic controller using a plurality of data sets, wherein the plurality of data sets are associated with a design of experiments (DOE) for the process recipe, and wherein each of the plurality of data sets comprises a unique combination of process parameter values and performance data.

5. The method of claim 1, wherein the first data set further comprises one or more constraints for process parameter values of one or more process parameters for the process recipe, wherein the one or more constraints indicate at least one of a) which process parameter values are adjustable, b) maximum permitted process parameter values for the one or more process parameters, or c) minimum permitted process parameter vales for the one or more process parameters.

6. The method of claim 1, further comprising:
determining one or more modeling error values based on a difference between the first performance data and first predicted performance data;
adjusting control coefficients of the dynamic controller based on the one or more modeling error values.

7. The method of claim 6, wherein the determining the one or more modeling error values based on the difference between the first performance data and first predicted performance data comprises:
determining a direction and magnitude of change in the difference between the target performance data and the first performance data.

8. The method of claim 1, wherein the processing the first data set using the dynamic controller to determine second process parameter values for the process parameters of the process recipe, comprises:
determining one or more performance error values based on a difference between the target performance data and the first performance data; and
generating second process parameter values based on the one or more performance error values.

9. The method of claim 8, wherein the determining the one or more performance error values based on the difference between the target performance data and the first performance data comprises:
determining a direction and magnitude of change in the difference between the first performance data and the first predicted performance data.

10. The method of claim 1, further comprising:
receiving a selection of one or more process parameters that are to be adjustable, wherein process parameter values for non-selected process parameters are not adjustable, wherein for the one or more selected process parameters the second process parameter values differ from the first process parameter values, and wherein for the non-selected process parameters the second process parameter values are the same as the first process parameter values.

11. The method of claim 1, wherein the first performance data and the second performance data each comprise one or more measurements from metrology data of a processed substrate that indicate one or more critical dimensions, the method further comprising:
processing the metrology data using a trained machine learning model to generate at least one of the first performance data or the second performance data.

12. The method of claim 1, further comprising:
processing a plurality of product substrates using the process recipe having the final process parameter values, wherein third performance data of the process recipe performed on the plurality of product substrates using the process recipe having the final process parameter values satisfies the one or more criteria with respect to the target performance data.

13. The method of claim 1, wherein the dynamic controller is a multiple input-multiple output (MIMO) controller.

14. A system comprising:
a memory; and
a processing device coupled to the memory, the processing device to:
receive a first data set for a first process run of a process recipe, the first data set comprising first process parameter values for process parameters of the process recipe, first performance data of the process recipe performed on a first substrate using the first process parameter values, and target performance data of the process recipe;
process the first data set using a dynamic controller to determine second process parameter values for the process parameters of the process recipe, wherein the second process parameter values differ from the first process parameter values for at least one process parameter;
receive a second data set for a second process run of the process recipe, the second data set comprising the second process parameter values, second performance data of the process recipe performed on a second substrate using the second process parameter values, and the target performance data of the process recipe; and
responsive to determining that the second performance data satisfies one or more criteria with respect to the target performance data, save the second process parameter values as final process parameter values for the process recipe.

15. The system of claim 14, wherein the processing device is further to:
responsive to determining that the second performance data does not satisfy the one or more criteria with respect to the target performance data, process the second data set using the dynamic controller to determine third process parameter values for the process parameters, wherein the third process parameter values differ from the second process parameter values for at least one process parameter.

16. The system of claim 14, wherein the processing device is further to:
prior to receiving the first data set, train the dynamic controller using a plurality of data sets, wherein the plurality of data sets are associated with a design of experiments (DOE) for the process recipe, and wherein each of the plurality of data sets comprises a unique combination of process parameter values and performance data.

17. A non-transitory machine-readable storage medium comprising instructions that, when executed by a processing device, cause the processing device to:
receive a first data set for a first process run of a process recipe, the first data set comprising first process parameter values for process parameters of the process recipe, first performance data of the process recipe performed on a first substrate using the first process parameter values, and target performance data of the process recipe;
process the first data set using a dynamic controller to determine second process parameter values for the process parameters of the process recipe, wherein the second process parameter values differ from the first process parameter values for at least one process parameter;
receive a second data set for a second process run of the process recipe, the second data set comprising the second process parameter values, second performance data of the process recipe performed on a second substrate using the second process parameter values, and the target performance data of the process recipe; and
responsive to determining that the second performance data satisfies one or more criteria with respect to the target performance data, save the second process parameter values as final process parameter values for the process recipe.

18. The non-transitory machine-readable storage medium of claim 17, the processing device further to:
responsive to determining that the second performance data does not satisfy the one or more criteria with respect to the target performance data, process the second data set using the dynamic controller to determine third process parameter values for the process parameters, wherein the third process parameter values differ from the second process parameter values for at least one process parameter.

19. The non-transitory machine-readable storage medium of claim 17, the processing device further to:
prior to receiving the first data set, train the dynamic controller using a plurality of data sets, wherein the plurality of data sets are associated with a design of experiments (DOE) for the process recipe, and wherein each of the plurality of data sets comprises a unique combination of process parameter values and performance data.

20. The non-transitory machine-readable storage medium of claim 17, the processing device further to:
determine one or more modeling error values based on a difference between the first performance data and first predicted performance data;
adjust control coefficients of the dynamic controller based on the one or more modeling error values.
